(19) United States
(12) Patent Application Publication
(10) Pub. No.: US 2024/0353363 A1
(43) Pub. Date: Oct. 24, 2024

(54) SENSOR MOUNTED STRUCTURE

(71) Applicant: Toyota Jidosha Kabushiki Kaisha, Toyota-shi (JP)

(72) Inventor: Yu HOSHINO, Toyota-shi (JP)

(73) Assignee: Toyota Jidosha Kabushiki Kaisha, Toyota-shi (JP)

(21) Appl. No.: 18/425,198

(22) Filed: Jan. 29, 2024

(30) Foreign Application Priority Data
Apr. 18, 2023 (JP) 2023-067842

(51) Int. Cl. G01N 27/22; B60H 1/00; B60R 1/22; B60R 11/00

(52) U.S. Cl. CPC G01N 27/223; B60H 1/00785; B60R 1/22; B60R 2011/0026

(57) ABSTRACT

A sensor mounted structure includes: a humidity sensor located on the inner surface of a front windshield; a cover that covers the humidity sensor; and a partition material that separates a space in the cover where the humidity sensor is located. A slit is formed in the cover to allow the space to communicate with the outside.

### CROSS-REFERENCE TO RELATED APPLICATION

This application claims priority to Japanese Patent Application No. 2023-067842 filed on Apr. 18, 2023, incorporated herein by reference in its entirety.

### BACKGROUND

### 1. Technical Field

The present disclosure relates to sensor mounted structures.

### 2. Description of Related Art

Conventionally, a sensor mounted structure for a vehicle is known in the art (see, for example, Japanese Unexamined Patent Application Publication No. 2019-99049 (JP 2019-99049 A)).

This sensor mounted structure is disposed in front of an overhead console in the longitudinal direction of the vehicle. This sensor mounted structure includes a camera sensor configured to detect the surroundings of the vehicle, and a cover that covers the camera sensor.

### SUMMARY

When a humidity sensor is housed in such a large cover as described above, there is room for improvement in order to ensure the detection accuracy of the humidity sensor.

The present disclosure was made to solve the above problem, and it is an object of the present disclosure to provide a sensor mounted structure that can ensure the detection accuracy of a humidity sensor.

A sensor mounted structure according to the present disclosure includes:
a humidity sensor located on an inner surface of a front windshield;
a cover that covers the humidity sensor; and
a partition material that separates a space in the cover where the humidity sensor is located.

The cover includes a communication portion that allows the space to communicate with outside.

With this configuration, air is introduced from the outside into the space where the humidity sensor is located through the communication portion, and the partition material allows the air to appropriately flow to the humidity sensor.

The above sensor mounted structure may further include a camera sensor configured to detect surroundings of a vehicle.

The camera sensor may be housed outside the space in the cover.

The cover may be located on an upper end portion of the front windshield.

The sensor mounted structure of the present disclosure can ensure the detection accuracy of the humidity sensor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of the sensor mounted structure of this embodiment viewed from diagonally below; and

FIG. 2 is a schematic diagram for explaining the sensor mounted structure of FIG. 1.

### DETAILED DESCRIPTION OF EMBODIMENTS

An embodiment of the present disclosure will be described below.

First, the configuration of a sensor mounted structure 100 according to an embodiment of the present disclosure will be described.

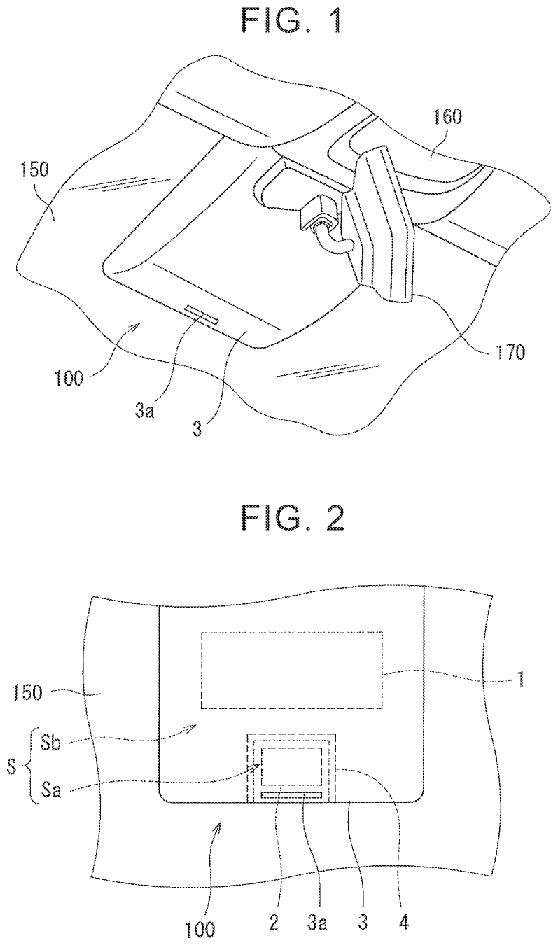

As shown in FIG. 1, the sensor mounted structure 100 is for a vehicle and is provided in a vehicle cabin. The sensor mounted structure 100 is provided on the inner surface of the front windshield 150 and is disposed on the vehicle front side of the overhead console 160. The overhead console 160 is attached to the ceiling of the vehicle cabin, and is located at the center of the front end of the ceiling in the vehicle width direction. An inner mirror 170 is provided near the overhead console 160.

As shown in FIG. 2, the sensor mounted structure 100 includes a camera sensor 1, a humidity sensor 2, a cover 3, and a partition material 4. The camera sensor 1 is provided to detect the surroundings of the vehicle. The detection results of the camera sensor 1 are used, for example, for vehicle driving support. The humidity sensor 2 is provided to detect the humidity on the surface of the front windshield 150 on the vehicle cabin side. The detection result of the humidity sensor 2 is used, for example, to control the operation of an air conditioner (not shown).

Camera sensor 1 and humidity sensor 2 are arranged on the inner surface of front windshield 150. The cover 3 is provided to cover the camera sensor 1 and the humidity sensor 2. The cover 3 is configured to form a housing space S between it and the front windshield 150. The housing space S houses a camera sensor 1 and a humidity sensor 2. Therefore, the housing space S of the cover 3 is larger than that of a cover (not shown) in which only the humidity sensor is housed. The cover 3 is located in the center of the upper end of the front windshield 150 in the vehicle width direction.

The partition material 4 is provided to divide the housing space S. The partition material 4 is formed integrally with the cover 3. The partition material 4 forms spaces Sa and Sb. The space Sa is an example of the “space” of the present disclosure.

The volume of the space Sa is smaller than the volume of the space Sb. The space Sa is arranged on the front side (lower side) of the vehicle in the housing space S, and is arranged at the center of the housing space S in the vehicle width direction. A gap (not shown) is provided between the space Sa and the space Sb, and the space Sa and the space Sb are not airtight. A humidity sensor 2 is arranged in the space Sa, and a camera sensor 1 is arranged in the space Sb. That is, the partition material 4 is provided so as to surround the humidity sensor 2, and is configured to separate a space Sa in the cover 3 where the humidity sensor 2 is located.

Moreover, one slit 3a extending in the vehicle width direction is formed in the cover 3. The slit 3a is arranged at a position facing the space Sa, and is provided to allow the space Sa to communicate with the outside. This outside is the outside of the housing space S inside a vehicle cabin. The slit 3a is formed to introduce air inside the vehicle cabin into the space Sa. The opening size of the slit 3a and the volume of the space Sa are set in advance so that the flow rate of air in the space Sa is ensured. For example, the slit 3a is arranged at the end of the cover 3 on the vehicle front side (lower side). The slit 3a is an example of the “communication portion” of the present disclosure.

In the sensor mounted structure 100, air is introduced into the space Sa through the slit 3a, and humidity is detected by the humidity sensor 2 as the air passes through. The air introduced into the space Sa flows out into the space Sb through the gap.

### EFFECTS

In this embodiment, as described above, the cover 3 that covers the camera sensor 1 and the humidity sensor 2 is provided, and the partition material 4 that separates the space Sa where the humidity sensor 2 is located is provided. A slit 3a is formed in the cover 3 to allow the space Sa to communicate with the outside. With this configuration, air can be introduced from the outside into the space Sa through the slit 3a, and the air can be appropriately directed to the humidity sensor 2 by the partition material 4. That is, air can be appropriately supplied to the humidity sensor 2 housed in the large cover 3. Therefore, the detection accuracy of the humidity sensor 2 can be ensured.

Moreover, since it is sufficient to ensure the flow rate of air in the space Sa, it is possible to suppress the opening size of the slit 3a from increasing. Thereby, it is possible to suppress a decrease in the rigidity of the cover 3 due to the slit 3a.

### Other Embodiment

The embodiment disclosed here is exemplification in all respects and is not a basis for a limited interpretation. Accordingly, the technical scope of the disclosure should not be interpreted based only on the above embodiment but is defined based on the description in the claims. All modifications within the meaning and the scope equivalent to the claims are included in the technical scope of the disclosure.

For example, in the embodiment described above, the sensor mounted structure 100 includes the camera sensor 1. The present disclosure is not limited to this, and the sensor mounted structure may not include a camera sensor.

Moreover, in the embodiment described above, an example was shown in which the partition material 4 is formed integrally with the cover 3. The present disclosure is not limited to this, and the partition material may be separate from the cover.

Further, in the above embodiment, an example was shown in which the space Sa and the space Sb were not made airtight. The present disclosure is not limited to this, and the space Sa and the space Sb may be made airtight.

Further, in the above embodiment, an example in which one slit 3a is formed is shown. The present disclosure is not limited to this, and a plurality of slits may be formed.

This disclosure can be utilized for the sensor mounted structure for vehicles.

What is claimed is:

1. A sensor mounted structure comprising:
a humidity sensor located on an inner surface of a front windshield;
a cover that covers the humidity sensor; and
a partition material that separates a space in the cover where the humidity sensor is located, wherein the cover includes a communication portion that allows the space to communicate with outside.

2. The sensor mounted structure according to claim 1, further comprising a camera sensor configured to detect surroundings of a vehicle, wherein:
the camera sensor is housed outside the space in the cover; and
the cover is located on an upper end portion of the front windshield.
